(19) United States
(12) Patent Application Publication
(10) Pub. No.: US 2016/0253050 A1
(43) Pub. Date: Sep. 1, 2016

(54) SYSTEM AND METHOD FOR AUDIO AND TACTILE BASED BROWSING

(71) Applicant: Fingertips Lab, Inc., San Franacisco, CA (US)

(72) Inventors: Pradyumna Kumar Mishra, San Francisco, CA (US); Byong-ho Park, San Jose, CA (US)

(21) Appl. No.: 15/054,064

(22) Filed: Feb. 25, 2016

Related U.S. Application Data
(60) Provisional application No. 62/121,429, filed on Feb. 26, 2015.
(60) Provisional application No. 62/214,499, filed on Sep. 4, 2015.

(51) Int. Cl. G06F 3/0482; G06F 3/0485; G06F 3/0484; G06F 3/0362; G10L 13/02; G06F 3/02; G06F 17/27; G06F 3/14; G05B 13/02; H04M 1/725; G06F 3/16

(52) U.S. Cl. CPC G06F 3/0482; H04M 1/72583; H04M 1/72522; G06F 3/0485; G06F 3/04842; G06F 3/0362; G06F 3/167; G06F 3/02; G06F 17/27; G06F 3/14; G05B 13/0265; G10L 13/02

(57) ABSTRACT

A system and method for a user interface that includes a controller apparatus that comprises at least two buttons and a rotary scrolling input element; a data connection between the controller apparatus and a navigable hierarchy of content; the rotary scrolling input element configured to communicate a change in selection state in the at least one navigable hierarchy of content; a first button of the at least two buttons configured to communicate a primary action on a currently selected item in the at least one navigable hierarchy of content; a second button of the at least two buttons configured to communicate a secondary action to the current state of the navigable hierarchy of content; and an audio engine that presents an audio interface output in response to communicated actions and navigation state of the hierarch of content.

### CROSS-REFERENCE TO RELATED APPLICATIONS

This application claims the benefit of U.S. Provisional Application No. 62/121,429, filed on 26 Feb. 2015 and U.S. Provisional Application No. 62/214,499, filed on 4 Sep. 2015 both of which are incorporated in their entireties by this reference.

### TECHNICAL FIELD

This invention relates generally to the field of user interfaces, and more specifically to a new and useful system and method for audio and tactile based browsing.

### BACKGROUND

The consumer electronics and computer industry has largely emphasized the design of devices necessitating visually-guided interactions with information such as from LED indicators, Graphical User Interfaces (GUI), screens/monitors, touchscreen displays such as iPhones, iPads, and Android smartphones, laptop/desktop computers, and heads up displays like Google glass and oculus rift. The predominant method to interact with Touchscreen devices is to be in close proximity to those devices necessitated by the need to touch the screen (unlike that of a laptops, TVs, or desktops) and the need to concentrate on the intense visual screen and user interface. Touchscreen devices such as Smartphones (e.g., iPhones, Android) and Smart watches are flat (lack tactile cues), vision intensive (e.g., small fonts, icons, keyboards), and require concentration and fine motor skills to operate. Further, most mobile applications are designed with visual-interaction (e.g., color, font size, shapes, layout, orientation, animations, among others) and physical proximity (e.g., touchscreen, small icons and fonts) in mind. Hence, these mobile applications are either difficult at best or even impossible to use not only for the visually impaired, physically impaired, and certain segments of older citizens, but also dangerous or inefficient for sighted users in contexts such as while driving (e.g., cops using touchscreen devices while driving, delivery drivers, use of Smartphone during personal transport), engaging in recreational sports (e.g., boating, running, bicycling, mountain climbing, hiking), working in industrial settings, and even in casual daily life situations where one's visual attention is applied elsewhere.

In the field of eyes-free browsing, a recent focus has been placed on voice interactions such as with Apple Siri and Google Voice where a user speaks commands. However, many users find the voice interactions frustrating and unsuitable for normal usage. Limitations of voice interaction includes being the tasks being mentally-taxing (high cognitive overload), needing cloud connectivity, and delays (in the order of seconds). Such interfaces are unsuitable for normal usage, and can be particularly unsuitable for use in environments that need low cognitive load interactions like in a vehicle.

Thus, there is a need in the user interface field to create a new and useful system and method for audio and tactile based browsing. This invention provides such a new and useful system and method.

### BRIEF DESCRIPTION OF THE FIGURES

FIG. 1 is a schematic representation of a system of a preferred embodiment;

FIGS. 2-4 are exemplary form factors of a controller apparatus;

FIGS. 5A-5D are exemplary input arrangements of a controller apparatus;

FIG. 6 is a detailed representation of differentiating inputs of a controller apparatus through textures;

FIG. 7 is a schematic representation of a controller apparatus and the orientation independence used in a vehicle application;

FIG. 8 is a schematic representation of a controller apparatus with data connections to multiple devices;

FIG. 9 is a schematic representation of a portion of navigable hierarchy of content;

FIG. 10 is a flowchart representation of a method of a preferred embodiment;

FIGS. 11-13 are schematic representations of interaction flows involving a scrolling actions, primary actions, reverting actions, and option actions;

FIG. 14 is a schematic representation of a visual interface in response to an option action;

FIGS. 15 and 16 are schematic representations of interaction flows involving primary actions, button patterns, shortcuts, and spoken directives; and

FIG. 17 is a schematic representation of a corresponding visual interface in response to an option action applying machine intelligence.

### DESCRIPTION OF THE EMBODIMENTS

The following description of the embodiments of the invention is not intended to limit the invention to these embodiments but rather to enable a person skilled in the art to make and use this invention.

### 1. System for Audio and Tactile Based Browsing

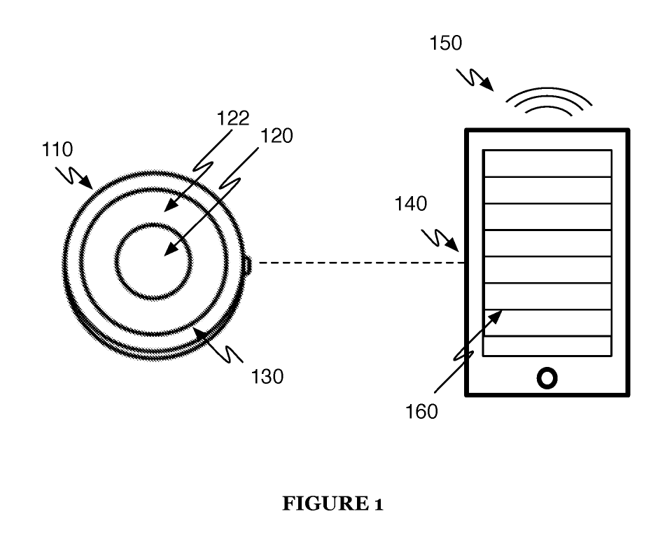

As shown in FIG. 1, a system for audio and tactile based browsing of a preferred embodiment can include a controller apparatus no with one or more buttons (e.g., buttons 120, 122) and a rotary scrolling input element 130; a data connection 140 between the controller apparatus and at least one navigable hierarchy of content; and an audio engine 150. The system can additionally include an application 160 with an audio interface and responsive to the communicated directives of the controller apparatus. The system functions to provide a substantially eyes-free multi-modal control interface with design elements that facilitate eyes-free remote browsing and remote control of applications. The multi-modal control interface preferably uses orientation independent form factor, tactile and audio based interface elements. The multi-modal control interface may additionally utilize visual and speech based input and feedback interface elements.

The system and method function to address many of the inadequacies of existing interface solutions. The system and method function to address the existing failure of current interface solutions to recognize the distinction between browsing and analytical search strategies. Voice interaction interfaces (e.g., Siri, Google Voice, etc.) do not offer a mechanism for convenient browsing-based interactions. The system and method can enable browsing through the quick examination of the relevance of a number of different objects, which may or may not lead to a closer examination, acquisition, and/or selection of one or more objects. The system and method provides a browsable interface by providing low cognitive load interactions, real-time exchanges, and collaboration between a controller and an information interface. In particular tactile interactions are more reliable, highly interactive, may require lower cognitive effort, and provide a better model for browsing than analytical search techniques. Additionally, tactile interactions that support browsing may be safer for vehicular interactions.

The system preferably offers eyes-free and eyes-assist interactivity within various contexts. The system may be used in situations where visual attention is directed to a different activity such as driving. The system can similarly be used for virtual reality and other use cases where a user may not want to or be able to provide visual attention. In some situations, the system may be applied in the accessibility field to enable the visually impaired to interact with a computer and/or media content.

In one embodiment, the system includes a physical controller apparatus 110 with convenient ergonomics and user inputs to wirelessly control at least one application running on a second device. The second device could be a phone, a smart wearable, a virtual reality/augmented reality system, a personal computer, an Internet of Things (IoT) device, remote service accessible over the internet, and/or any suitable computing device or service. Additionally, the system can provide control across a set of different devices and/or applications. The system can additionally be adaptive to different contexts, and the system may enable the browsing of a variety of media content. The system can be used in interacting with web articles and media streams (e.g., social media messaging, picture sharing, video sharing), navigating an application or computer, or controlling a physical device, or performing any suitable interaction.

The controller apparatus 110 functions as a tactile-based input interface for interacting with an at least partially audio based output interface. The controller apparatus 110 can serve as a substantially eyes-free remote that may necessitate virtually no visual and minimal cognitive attention to enable full control of a device such as a mobile phone, a remote household device, or any suitable device. A key element of the controller apparatus 110 design is that the user may be alleviated from orienting the device in a particular orientation. In one use case, identification of a top face of the controller apparatus 110 can be sufficient for user interaction. This saves the user time when they use it and further enables eyes-free interaction with the device because the user can consistently identify the first button 120, second button 122, additional buttons (e.g., a third button 124), and the rotary scrolling input element 130.

To facilitate eyes-free and minimal cognitive effort operation, the controller apparatus 110 can include design features that may substantially promote easier tactile interactions such as: incorporation into accessories to reduce the effort for locating and reaching for the device; a compact form factor for ease of placing or holding the device; an orientation-independent design; ease of locating interaction elements through placement, input size, input texture, and/or other guiding features; tactile feedback such as dynamic resistance or haptic feedback to indicate input state; and/or other design features.

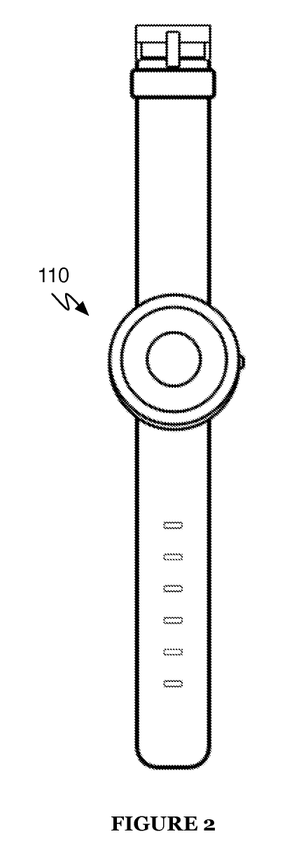

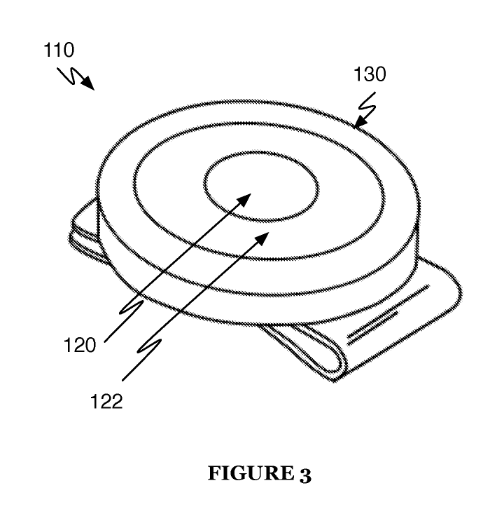

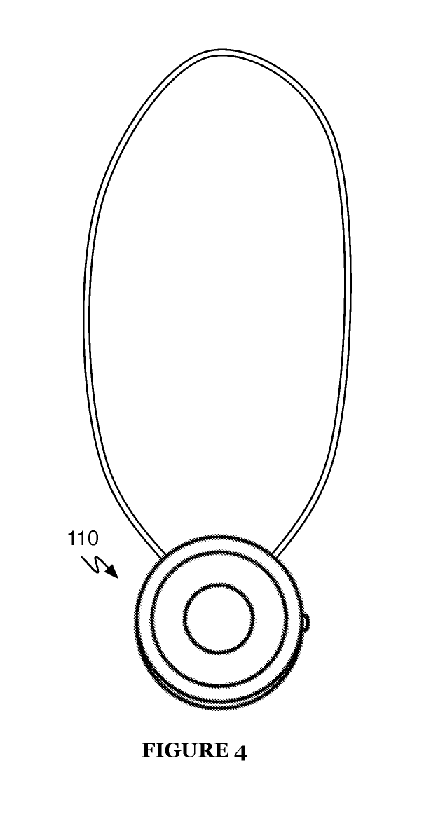

The controller apparatus 110 includes a body, which can be in a variety of forms and made of a variety of materials. The controller apparatus no supports various accessories enabling the controller apparatus no to be worn on the wrist with either a watchband as shown in FIG. 2 or a bracelet, clipped on to the pocket or belt with a pocket-clip accessory as shown in FIG. 3, worn as a necklace with the necklace or lanyard accessory as shown in FIG. 4, placed on a coffee table or attached to the fridge, mounted within a vehicular dashboard, or used in any suitable location. The controller apparatus 110 can be a standalone element. In one variation, the controller apparatus 110 can be physically coupled to various cases, holders, or fixtures. Additionally or alternatively, the structural element of the controller apparatus 110 can be incorporated with a watch, a pendant, headphones, a keychain, a phone or phone case, a vehicle, and/or any suitable device.

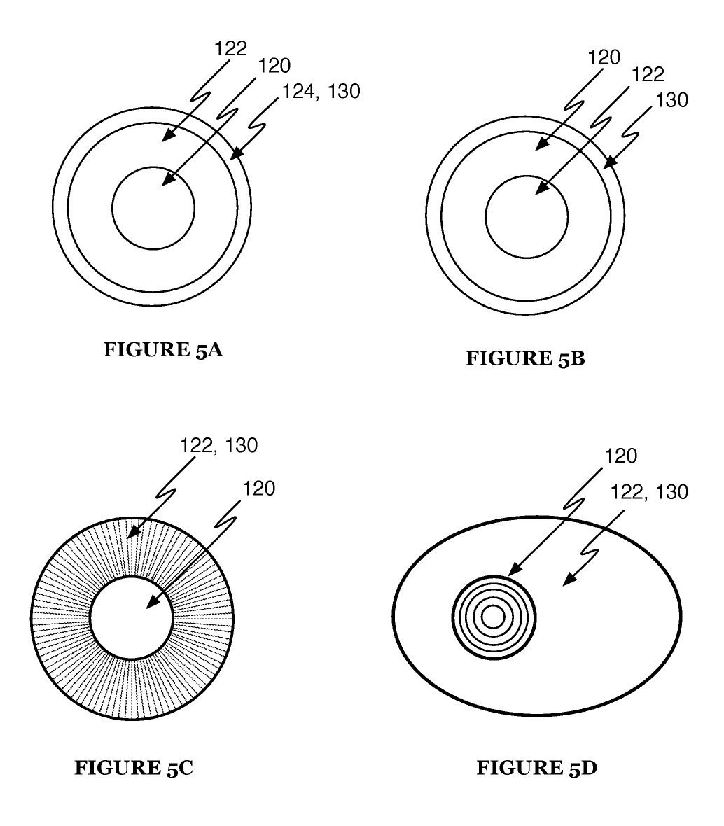

The controller apparatus no can include at least one button 120, 122 and a rotary scrolling input element 130. In one embodiment, the button 120, 122 and the rotary scrolling input element 130 are positioned in a radial distribution, which functions to promote an orientation-independent design. The radially distributed arrangement can be concentric or otherwise symmetrically aligned about at least one point as shown in FIGS. 5A-5C. However, some variations may have an asymmetric or non-concentric arrangement as shown in FIG. 5D. In another embodiment, the button can be split into two buttons. In a radially distributed arrangement, a user using the controller apparatus no can know that the inputs are positioned in rings at distinct distances without looking at the device: pressing in the center can illicit one type of action, pressing outside of the middle can illicit a different action; and the rotary scrolling input is at a differ portion. The rotational orientation of the controller apparatus 110 preferably does not change where a user may act on an input. One of the buttons 120, 122 preferably circumscribes (or more specifically concentrically circumscribes) the other button. In exemplary implementation shown in FIG. 5A, the second button 122 surrounds the first button 120 and the third button 124 surrounds both the first and second button. In another exemplary implementation, the first button circumscribes the second button as shown in FIG. 5B. The rotary scrolling input element 130 preferably circumscribes the buttons. The rotary scrolling input element 130 may alternatively have a circumscribing button. The rotary scrolling input element 130 can be integrated with at least one button, wherein the rotary input element 130 can be activated either as a scrolling input or a button input as shown in FIGS. 5A and 5C.

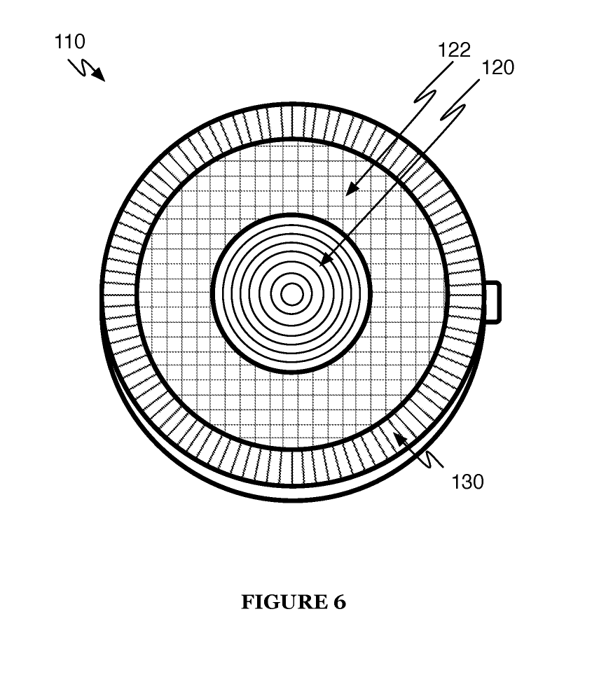

Additionally, texture, materials, and form may be used with the input elements to guide the user. In one variation, at least one of the buttons 120, 122 may have a convex or concave surface. In another variation, at least one of the buttons can have a distinct surface texture. The input elements of the controller apparatus 110 may be distinguished using any suitable feature. Alternatively, there can be a slight bump or wall between two buttons for a tactile distinction. In one example, the rotary scrolling input element 130 can have ridges, the second button can have a lattice texture pattern, and the first button can have a surface pattern of concentric circles as shown in FIG. 6.

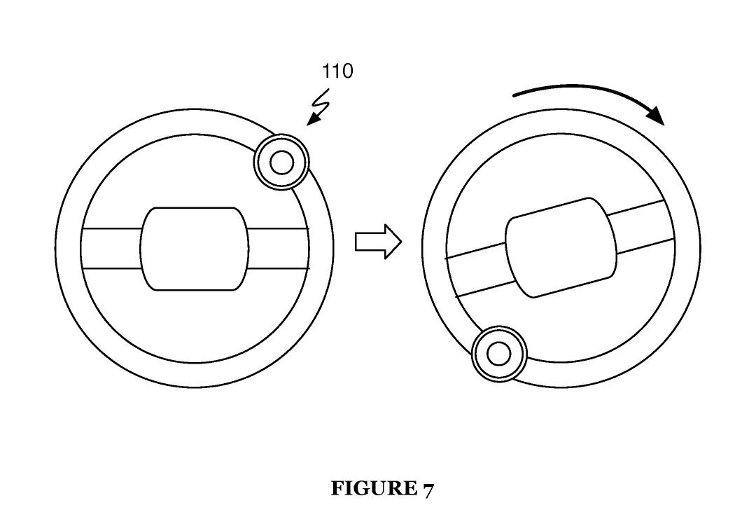

In one particular embodiment, the controller apparatus 110 includes a fixture interface compatible with a steering wheel. The controller apparatus 110 can be permanently or removably coupled to a steering wheel of a vehicle. For example, the fixture interface of the controller apparatus 110 can be a clip that snaps around the outer rim of a steering wheel. The orientation-independence is particularly applicable in such a use case since the steering wheel will be constantly turned as shown in FIG. 7. The controller apparatus 110 can be placed at any suitable location on the steering wheel: in the center, on outer edge in the front, on the back of the steering wheel. However, the interaction through the controller apparatus 110 can be maintained (e.g., the center button is still the center button).

The controller apparatus 110 preferably uses physical inputs such as physically rotatable dials and articulating buttons. The controller apparatus may alternatively include digital inputs that simulate physical inputs through use of sensing technologies. A touch sensitive surface (e.g., a capacitive touch screen) can be used in place of one or more inputs. In one embodiment, the controller apparatus no can be a digital or virtual interface. For example, a smart phone, smart watch, or other wearable may have an application where a digital version of the controller apparatus 110 can be used in controlling other devices.

Tactile feedback may be incorporated as dynamic and/or variable resistance for the input elements like the buttons or the rotary dial. For example, no resistance may mean the button is not pressed or the button doesn't have an available action. The tactile feedback can additionally use varying tactile forces, cues, and degrees of displacement. The tactile feedback can additionally be used to signal interaction feedback. For example, a confirmatory tactile click can be activated during use of a button or the rotary dial 130.

The rotary scrolling input 130 functions to enable selection or navigation between along at least one dimension. The rotary scrolling input 130 is preferably configured to communicate a change in selection state in the at least one navigable hierarchy of content. Interaction with the scrolling input 130 may signal changes in rotation but may additionally or alternatively use rate of rotation, pressure/force and rotation, rotating pattern (e.g., scrubbing back and forth), and/or any suitable type of scrolling property. The rotary scrolling input 130 is preferably used in scrolling between previous and next items in a sequence (e.g., a list or set of digital items). The rotary scrolling input 130 can additionally be used in adjusting a value such as increasing or decreasing a variable value (e.g., setting the volume, speech-rate, temperature, etc.), entering alphanumeric information, selecting a set or items, making discrete input (e.g., rotating clockwise to approve and counter clockwise to cancel a transaction), or providing any suitable input. In one implementation the rotary scrolling input 130 is a bezel dial that can physically rotate clockwise and counter-clockwise. The rotary scrolling input 130 is preferably one of the outermost input elements of the controller apparatus no. The rotary scrolling input 130 may alternatively be positioned within an inner radial region or alternatively across the entirety of at least one surface of the controller apparatus no. The rotary scrolling input 130 can be textured to provide grip. The rotary scrolling input 130 can rotate smoothly, but may alternatively rotate with a ratcheted effect. In one variation, the rotary scrolling input 130 can have dynamically controlled resistance and/or ratcheting features to provide varying forms of tactile feedback. The dynamic tactile feedback of the rotary scrolling input 130 is preferably updated according to the state of a controlled interface or device. Additionally or alternatively, the rotary scrolling input 130 can simulate tactile feedback through audio cues such as clicking sounds activated as the rotary scrolling input 130 is rotated. The rotary scrolling input 130 can alternatively be a sensed scrolling input device without physical movement. A capacitive surface or any suitable form of touch detection can be used to detect rotary scrolling within a particular area. The rotary scrolling input 130 can additionally be combined with one or more button. In one variation, the rotary scrolling input 130 is integrated with a button wherein the rotary scrolling input 130 and the at least one corresponding button act as a clickable and rotatable element.

The at least two buttons of the controller apparatus no function to receive at least two types of directives of a user. As described above, the buttons are preferably physical buttons but may alternatively be digital buttons, which detect taps or presses on a surface. The buttons can be substantially similar types of buttons, but different types of buttons may be used. The various buttons are preferably arranged on the controller apparatus 110 so that the buttons are orientation independent such that the buttons can be accessed and consistently engaged in a relative static position regardless of the rotational orientation of the controller apparatus no.

A first button 120 of the at least two buttons can be configured to communicate a primary action on a currently selected item in the at least one navigable hierarchy of content. The primary action is preferably a selecting action which may open a folder a branch in a hierarchy of content, play a file (e.g., play a podcast, music file, or video file), initiate some process (e.g., starting an application, confirming a transaction), or trigger any suitable default directives. The first button 120 is preferably configured within the controller apparatus no to communicate the primary action to at least one navigable hierarchy of content through the data connection 140. The navigable hierarchy of content can, in part, be browsed by using the rotary scroll element 110 to select an option and the first button 120 to trigger a primary action on at least one option. The state of the navigable hierarchy of content can be updated to reflect the activation of an option. Activation of the first buttons 20 may open another list of options, but may alternatively start playing some media, application, or process.

The first button 120 may additionally be configured to communicate a contextually aware option action upon detecting a pattern of button events. A pattern of button events can be multiple button clicks with particular temporal pattern (e.g., a double-click), a sustained button click, a pressure based button events (e.g., a hard click vs. a soft click), and/or any suitable type of button activation pattern. Patterns of button events can provide various shortcuts or advanced user features. The action applied can be contextually aware based on the state of the navigable hierarchy of content. For example, one action may be initiated if one item is selected in the hierarchy of content, a second action may be initiated if a second item is selected in the hierarchy of content, and a third type of action may be initiated when playing a particular type of media file.

A second button 122 of the at least two buttons can be configured to communicate a secondary action. In many preferred modes, the second button 122 communicates a reverting action to the current state of the navigable hierarchy of content as the secondary action. The reverting action can be used to go back to a previous state in the navigable hierarchy of content, cancel some previous action, decline an option, undo some action, exit a program, or perform any suitable reverting action. In the example above, the second button 122 can be used to navigate backwards to a previous state of the navigable hierarchy of content. For example, an application may initiate in a main menu that lists different types of content such as email, social media stream, podcasts, news, and the like. If a user navigates to the email option by selecting and activating that option, the user can return to the main menu by activating the second button 122. The second button 122 can include any of the variations of the first button 120. For example, the second button 122 may additionally be configured to communicate a different contextually aware option action upon detecting a pattern of button events.

The controller apparatus no may include any suitable number of buttons or other user input elements. In one embodiment the controller apparatus no includes a third button 124. The third button 124 is preferably configured to communicate a contextually aware options action according to the current state of the navigable hierarchy of content. In one preferred embodiment, the third button 124 activates a contextual menu of options. These options may include secondary (and possibly the default) actions that can be performed during the current state of the navigable hierarchy of content. For example, if a podcast is selected in the interface, then activating the third button 124 may bring up a list of options that include playing the podcast, favoriting the podcast, deleting the podcast, sharing the podcast, or performing any suitable action. The action of the third button 124 is preferably contextually aware. In the example above the options would be different if the podcast was already being played—the options could include pause the podcast, bookmark the place in the podcast, change volume, change playback speed, change position in the podcast, or any suitable manipulation of the podcast.

Any suitable arrangement of the buttons may be used. For example, an inner button may be positioned in the center of a concentric arrangement with a middle button in a middle ring, and an outer button integrated with the rotary scrolling element 130 on the outer edge. The button actions can be mapped to the various buttons in any suitable mapping such as the first button as the inner button, the middle button to the second button, and the third outer button as the third button. Alternatively, the first button may be the outer button, the second button as the inner button, and the third button as the middle button.

The inputs of the controller apparatus 110 can include haptic feedback elements. A vibrational haptic feedback element (e.g., a vibrational motor) can be used to provide haptic feedback through the controller apparatus 110. In one embodiment, the controller apparatus no can function as a haptic watch that tells time in terms of hours and minutes by pressing the buttons. For instance, the center button and the middle button can represent hours and minutes respectively. When either button is pressed, it can tell exact hour and minute through certain number of vibrations.

Additionally, the controller apparatus no can include a voice input system. The voice input system preferably provides a natural language user interface where a user can speak instructions to the controller apparatus. The voice input system preferably can supplement interaction. Preferably, the voice input system can be used as a way of executing some shortcut action. A set of universally available actions may be available. For example, a user may be able to say “home” to return to a main menu, or a user could say “play album 123” to play an album titled 123. The voice input system may additionally be used for dictation if the user needs to enter long amounts of text. Other forms of user input can additionally be integrated with the controller apparatus 110 such as inertial measurement (IMU) controls. IMU controls can produce movement and orientation measurements using an accelerometer, a gyroscope, a magnetometer, and/or any suitable movement and orientation based sensing mechanism. In one embodiment, the IMU can be used for elderly health or security monitoring. For instance, when elderly wearing the device suddenly falls to the ground, the IMU can pick up the sudden change in movement and the connected device can send a message or alarm to family members or 911 for urgent care. Also when there is a safety or health issue, the user can push the buttons in a preconfigured fashion to activate the communication with family members or send an alarm to 911. Other forms of input for the controller apparatus 110 can include a capacitive touch surface, which may offer multitouch or single point gestures, near field communication (NFC) or radio frequency identifier (RFID) readers, or other suitable input elements. In another embodiment, the controller apparatus can be used to unlock car doors, house doors, security locks, etc. Certain combination of the buttons or the pattern of the rotary dial movement can be implemented as a simple and intuitive user interface for security applications.

The data connection 140 between the controller apparatus no and at least one navigable hierarchy of content, functions to relay the directives used to control some device and/or application. The data connection 140 is preferably a wireless data communication. The wireless data communication can be Bluetooth, Wi-Fi, infrared, and/or any suitable form of wireless communication. In one implementation, the data connection 140 is a Bluetooth data connection 140, wherein the controller apparatus no simulates a Bluetooth connected device. A Bluetooth device or any suitable type of wireless (or wired) device interface may be used to act as a keyboard, joystick, mouse, trackpad, custom device, media controller, and/or any suitable type of controller device. For instance, the controller apparatus no can be used to control popular application such as Netflix via other devices (e.g. Roku, Apple TV, Amazon Fire TV, etc). The data communication 140 may alternatively be a direct data communication channel. A direct data communication may occur through messaging protocols of an operating system, be established over a USB or wired connection, or established in any suitable manner.

The navigable hierarchy of content can be within an application, but may alternatively be defined by an operating system or across a set of devices. For example, an app-based operating system includes a home view with multiple applications. Each of the applications forms a branch in the navigable hierarchy of content, and within each app there can be content, which may be similarly navigated. In some cases, content may not be readily accessible for browsing. A conversion engine can process the content and generate navigable content. For example, a website intended for visual browsing can be processed and broken down into navigable elements. Machine learning, heuristics, and/or other media intelligence can be used in parsing the content and generating summaries, identifying relevant content, generating possible actions or responses to the content, or any suitable information. The website may be summarized into a set of different elements, which can be more readily browsed using the system. Similarly, an email may be analyzed and a set of possible replies can be generated, and a user can easily select those auto-generated responses using the system.

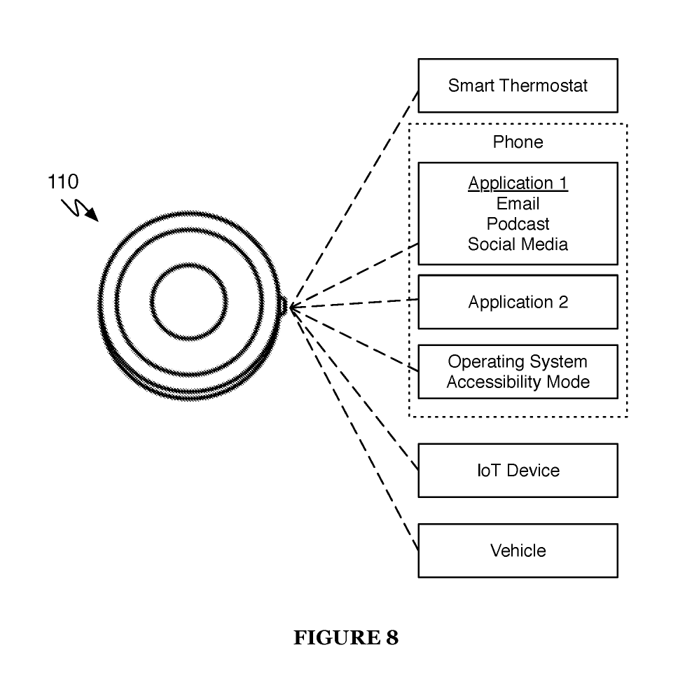

Preferably, the data connection 140 is established between the controller apparatus 110 and a smart phone or personal computing device. Alternatively, the data connection 140 can be established between the controller apparatus no and a vehicle media system, a home automation device, a connected device, a television, and/or any suitable device as shown in FIG. 8. Similarly, the data connection 140 could be to a remote service, platform, or device, wherein communication is facilitated over an internet or carrier network. The data connection 140 can additionally be changed between devices. In one variation, the data connection 110 can be switched to at least a second navigable hierarchy of content where the first and second navigable hierarchies of content are for different distinct devices. This switching can be manually activated by changing the data connection 140 of the controller apparatus 110. In another variation, the controller apparatus 110 can detect previously synced or discoverable devices and present them as navigable options within the hierarchy of content. From the user's perspective the user is simply navigating a unified body of content.

In one variation, the controller apparatus 110 can be used for controlling a device such as a smart phone with an operating system. Applications can implement particular protocols to recognize and appropriately integrate with the controller apparatus no. However, other applications or modes of the operating system may not implement such features. The controller apparatus 110 can use accessibility features of the operating system in such a case to still provide control. In this variation, the controller apparatus can be configured for at least two modes of control over at least two types of navigable hierarchies of content. The action commands for the at least two modes of control can be transmitted simultaneously through the data connection 140, which functions to delegate the decision of which mode to use to the receiving device or application. The receiving device will preferably be responsive to only one mode of control at any one given time. A first mode of control is smart audio navigation for an application with audio navigation integration and the second mode of control can be an accessibility mode for device accessibility tools. Other modes of control may additionally be offered. Since the controller apparatus 110 may connect with a device as a Bluetooth keyboard, the two modes of control can be transmitted by sending multiple keyboard commands in response to user input at the controller apparatus no. For example, selection of the first button can initiate transmission of a selection key code as specified for accessibility protocol of the device and simultaneously transmitting the “play” key code recognized by applications with integration.

The audio engine 150 functions to provide auditory feedback to a user. The system preferably promotes eyes-free interaction, and the audio engine 150 preferably facilitates that. The audio engine 150 preferably presents an audio interface output in response to communicated actions and navigation state of the hierarch of content. The audio engine 150 is preferably operable within or on a secondary device. The audio engine 150 can alternatively be operable in part or whole on the controller apparatus 110, wherein the controller apparatus generates the audio. Additionally, the audio engine 150 may be distributed where multiple connected devices include a local audio engine 150 for producing audio relevant to that device. The audio engine 150 can additionally include an audio content browser and a set of voice synthesizers, wherein the audio content browser is configured to translate media content to an audio description using one of the voice synthesizers. The audio engine 150 preferably reads and/or plays content to a user. The information is preferably intelligently presented for both the menu options and the content.

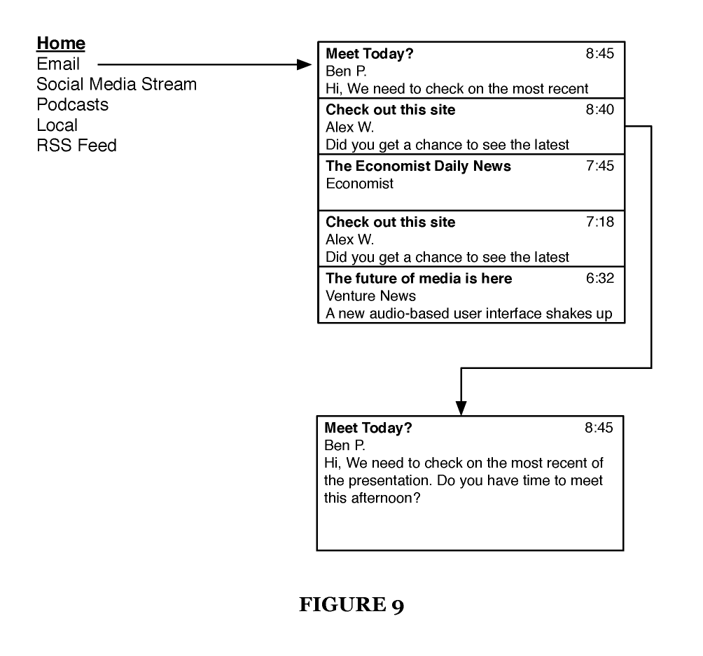

In one variation, the audio content browser can process and procedurally generate portions of the hierarchy of content. The generated content is preferably automatically generated audio stream information, which can minimize the need for users to look at touch screens or displays for interactions. The audio content browser may generate content in real-time or pre-generate the content. The audio content browser can have a set of different integrations so that it can generate suitable audio interfaces for a variety of media items. The audio content browser may have integrations with email, a contact book, messaging, social media platforms, collaboration tools (e.g., work applications used for team chat), music/media, a web browser, particular websites, news or feeds, a media device (e.g., camera or microphone), a file system, saved media, documents, IoT devices, and/or any suitable content source as shown in FIG. 9. The audio content browser can generate how particular pieces of content will be presented through an audio interface. Content may have a summary version, which would be used when highlighting that option within a set of other options, and may have a detailed version, which would be used when that content item is activated. Additionally, content (such as a website) may be decomposed into more readily navigated pieces of content. For example accessing the front page of a popular news site traditionally will display top stories, a weather summary, and highlights of the various news sections. The audio content browser may decompose the website into a list of different sections for easier browsing. Similarly, a piece of media content like an article, an email, a social media post may be processed into a set of media content wherein the first piece is the presentation of the media content and then subsequent items presented to the user are action options that can be activated using the controller apparatus no.

The audio content browser can act as a channel generator generating a sequence of tracks for each channel such as for a social network timeline and emails. These tracks are ordered in a temporal sequence, but they are not necessarily played in strict temporal order; sometimes, the most recent (newest) track gets precedence over the scheduled track in the temporal sequence. This ensures that the newest content is surfaced to the user first and the user gets to hear and act on the latest and up-to-date content.

Channels also have the ability to resolve hyperlinks. For instance, if a social media post contains a hyperlink to an online article, the audio content browser will first speak the social media post, followed by an audio indication and description of the article (e.g. audio beeps both at the start and end of the description of the link). If spoken audio content for the article is available, then audio content browser will provide the user the option to play that audio following the social media post, but if human spoken audio is not available, the audio content browser then converts the printed article to audio via synthesized speech and then provides the user the option to play that audio; the user can play (i.e. activate) the link by clicking or touching or activating a button on a remote controller while the link is being described. The hyperlink may alternatively be activated through any suitable interaction such as a voice command (e.g., “play link”). Hyperlinks can additionally be used with other documents like text files, images, video files, presentation files, and/or any suitable type of document. Hyperlinks may also be used with application specific content wherein deeplinking to other applications or services can be enabled. In one variation a hyperlink item can be activated by selecting the action button, and the most recently presented option will be activated. So if a link is described and then audio proceeds after the link, the link may still be activated by pressing the first button before another action is presented.

The audio content browser can be configured with logic and heuristics for processing content, but the audio content browser can additionally apply artificial intelligence to improve processing of content and generating audio interfaces of such content. For example, the audio engine 150 could learn preferences of one or more users and tailor the summarization of content based on user tendencies as identified through past interactions of one or more users.

In another variation, the delivery of the content can be customized to enhance engagement through the audio interface. The audio engine will use automated text to speech system to read text to the user. The text to speech system can include multiple voices and accents, which can be used according to the content. For example, when reading emails to a user, the gender of the voice of the text to speech system can be adjusted corresponding to the gender of the sender of the email. Similarly, when reading the news, an American accent can be used for news reported about the United States and a British accent may be used for news about the UK. Additionally, audio cues (e.g., jingles, bells, whistles), music, and background noise can be used to signal different information to the user. The user will preferably want to be able to browse content swiftly. Dynamic audio delivery can provide ways for the user to more quickly make decisions about their actions (e.g., whether to skip an item, to select it, delete it, and the like).

The system can additionally include an application, which functions to manage at least a portion of the navigable hierarchy of content. In a preferred variation, the application is a channel-based application that provides a customized experience for audio-based navigation of content through the controller apparatus 110. In a channel-based application various branches of the hierarchy of content can be presented as “channels” of content. For example, email, social media streams, podcasts, websites, and/or other channels of content can be browsed. A user may additionally customize the channels. Various services may offer adding channels to the channel-based application. Alternatively, an application may use a software development kit (SDK), a library, or adhere to a specified protocol to offer an audio-based interface controlled through the controller apparatus no. This programmatic integration can enable a variety of third-party applications to take full advantage of the system. The application preferably uses the audio engine 150 and audio content browser.

The application can be operable on a device offering a visual interface. The application can include a visual interface simultaneously with the audio interface. Preferably, the audio and visual interfaces are synchronized to represent single application state. Alternatively, the visual interface and the audio interface can be at different states. For example, a user may start a podcast through the audio interface, but then while the podcast is playing browse other content items within the hierarchy of content.

The audio engine 150 described above can be used within the application to curate online content. The content can be personalized for a particular user. The application is preferably used with the controller apparatus 110 offering a complete eyes-free interaction. However, in one alternative embodiment, the application 150 in combination with the audio engine 140 may be used with an alternative controller. The alternative controller can use alternative forms of interaction and may not be orientation-independent. For example, a typical TV remote or Apple Watch may be used to control an application. A user could interact and browse the personalized audio content using a traditional and familiar interactive controls of an audio system such as but not limited to playing/pausing, skimming, fast-forwarding, rewinding, increasing/decreasing volume and speech rate, and changing channels.

### 2. Method for Audio and Tactile Based Browsing

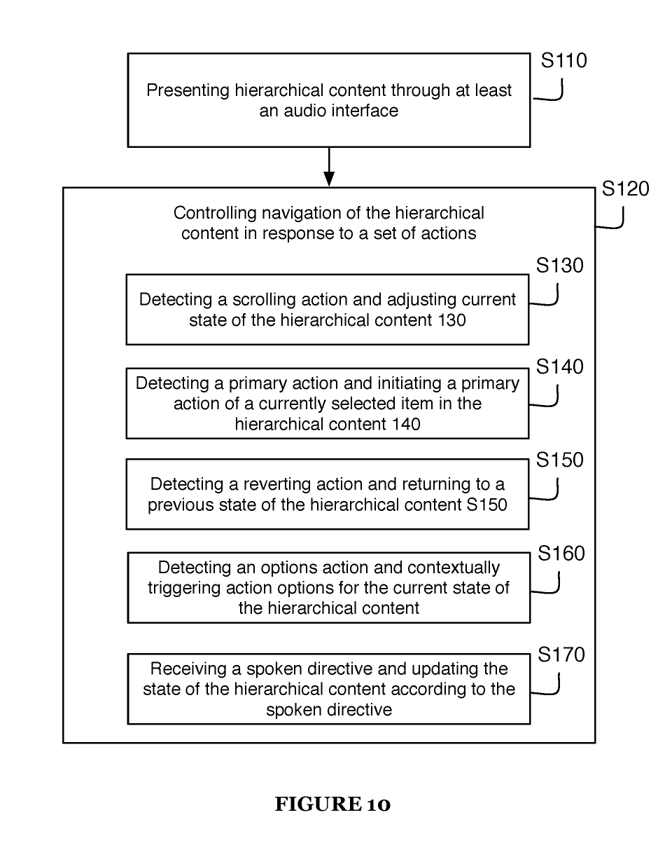

As shown in FIG. 10, a method for audio and tactile based browsing of a preferred embodiment can include presenting hierarchical content through at least an audio interface Silo, controlling navigation of the hierarchical content in response to a set of actions S120 which include detecting a scrolling action and adjusting current state of the hierarchical content 130, detecting a primary action and initiating a primary action of a currently selected item in the hierarchical content 140; and detecting a reverting action and returning to a previous state of the hierarchical content S150.

The method functions to provide an eyes free user interface of content. The method can be applied to the browsing of a variety of media and content types. As one aspect of the method of the preferred embodiment, various media and content formats are automatically converted to “channels” (i.e., branches of hierarchical content) such that the content can be presented to the user in a usable audio based format, which promotes ease of user interactions. Rather than designing the user interactions with a visual interface first approach, the method makes the audio-based browsing of different content a first class citizen in the field of user interfaces. The architecture and generation of content is tailored for ease of user interaction in an eyes free user interface. The method can be used for browsing emails, social media, websites, files systems, databases of information, websites, media files (e.g., audio, video, images), interactive media (e.g., digital environments, virtual reality, augmented reality, and other simulated environments), physical devices, and/or other forms of digital content. In one sense, the method is used to convert content traditionally browsed and accessed via visual interfaces into a form of interactive audio based radio channels.

The method is preferably used in combination with a tactile based user input interface. The method is preferably implemented by a system as described above. Preferably, the primary action and the reverting action are received from two different button events of a controller apparatus, and the scrolling action is received from a rotary scrolling element of the controller apparatus. Preferably, the controller apparatus is an orientation-independent device, wherein a second button can circumscribe a first button in an orientation independent arrangement. For example, the first button and second button can be concentric rings. The inner button (e.g., the first button) can be a circle or a ring with a defined opening in the center, and the outer button is a ring surrounding the inner button. The rotary scrolling element can similarly circumscribe the buttons, but may alternatively be integrated with one or more of the buttons. There can be additional input elements such as a third button and other forms of input elements used in managing the method. The method any alternatively be implemented by any suitable alternative system using any suitable controller. In one embodiment, the method is used in combination with an orientation dependent controller such as a TV remote.

Block Silo, which includes presenting a hierarchical content through at least an audio interface, functions to produce application state feedback through an audio based medium. Presenting a hierarchical content includes determining how to present an audio format of content, reading navigational options, and playing an audio representation of media content. Presenting a hierarchical content preferably uses synthesized voices from a text to speech system, but may additionally use pre-recorded messages. Messages are preferably announced to a user from a computing device. As described above, the computing device may be personal computing device that is being remotely controlled by a controller. The personal computing device could be a smart phone, a wearable, a home automation device, a television, a computer, or any suitable computing device. The computing device may alternatively be the controller.

Branches of the hierarchical content can be organized as channels. The channels can be based on the content source, the content type, properties of the content, or any suitable property. Channels (i.e., or branches of the hierarchical content) can include sub-channels, where a user may have to navigate through multiple levels of channels to access desired content.

The text to speech system can include multiple voices and accents, which can be used according to the content. For example, when presenting a set of options to a user, the gender of the voice of the text to speech system can be adjusted corresponding to the properties of the options. Similarly, when reading the news, an American accent can be used for news reported about the United States and a British accent may be used for news about the UK. Additionally, audio cues (e.g., jingles, bells, whistles), music, and background noise can be used to signal different information to the user. The user will preferably want to be able to browse content swiftly. Dynamic audio delivery can provide ways for the user to more quickly make decisions about their actions (e.g., whether to skip an item, to select it, delete it, and the like).

Presentation of the hierarchical content is preferably based on the current state of the hierarchical content. The state of the hierarchical content can be dependent on the current position within the hierarchical content (i.e., browsing application state). A user can preferably browse the content by navigating through different options and/or activating one of the options. Activating an option can update the navigational state in the hierarchical content, play an associated media file, toggle a setting, or perform any suitable action. Presenting hierarchical content can include at least two modes: a selection mode and activation mode.

In a selection mode, presenting the hierarchical content includes presenting a list of options for the current position. The set of options is preferably the navigation options available for the current in the hierarchical content. Presenting the hierarchical content can include progressively playing an audio summary of the set of options. As the audio interface cycles through the options the corresponding option can be selected (so that actions may be performed on that action). The rotary scrolling element may additionally be used in manually cycling through the options.

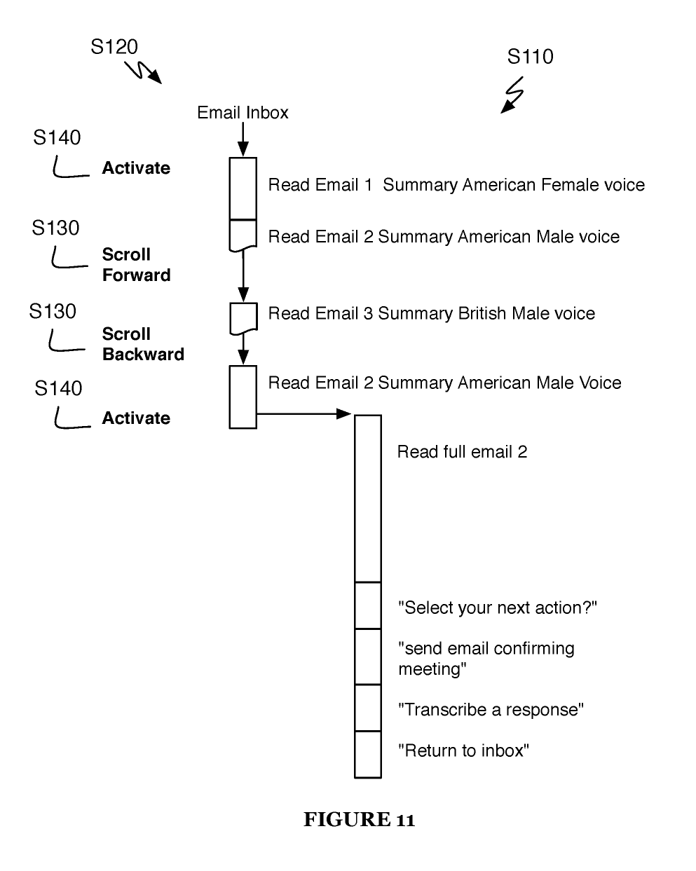

For example, at the main menu (i.e., the root of the hierarchical content), the list of branches or channels can be announced in an audio format. As the set of options is announced, the selected option can be updated to correspond with the audio. So as the channel options are being announced, a user may initiate a primary action that opens up the current selection. If the current selection is an email channel, then a set of email summaries is accessed and presented as shown in FIG. 11. In this example, a scrolling input may be used to update the selection state to the next or previous email in the set of options. To read an email, an email can be selected while that email summary is selected and being presented. Then the presenting audio can change state to present the full content of that email. Optionally, a set of action options can be presented after the email.

In an activation mode, the selected content item in the hierarchical content is opened, played, or otherwise activated. For example, if the content item references an audio file, the audio file may be played; if the content item references a toggle switch, the state of the switch can be toggled, if the content item references some action like “confirm purchase”, the action is triggered. In an activation mode, the audio interface can play a confirmation message and then return the navigation state to a previous state. Alternatively, the audio interface may present options of what action the user wants to perform next such as “return to the main menu”, “return to previous menu”, or “cancel action”.

Presenting the hierarchical content through at least an audio interface can additionally include rendering the navigational state of the hierarchical content visually. Preferably, the visual interface and the auditory interface are synchronized so that one may interact with either interface. Alternatively, the audio interface may be navigated independently from the visual interface.

Block S120, which includes controlling navigation of the hierarchical content in response to a set of actions functions to update the state of the application according to user input. As described above, the manner in which the hierarchical content is presented in an audio medium can promote and enable intuitive navigation. Various forms of control may be used. Preferably, a controller apparatus as described herein can be used in which case controlling navigation of the hierarchical content may include detecting a scrolling action and adjusting current state of the hierarchical content 130, detecting a primary action and initiating a primary action of a currently selected item in the hierarchical content 140; and detecting a reverting action and returning to a previous state of the hierarchical content S150. Alternatively or additionally, other forms of controllers may be used.

Control of navigation is preferably responsive to a set of directives communicated to an application or device. More preferably, those directives are received over a wireless communication medium. In one variation, a controller can be paired to one or more devices using Bluetooth or a wireless internet connection. In the Bluetooth variation, the controller may be paired as a Bluetooth accessory and more specifically as a keyboard or accessibility tool capable of transmitting key codes. In one variation, controlling navigation includes receiving at a device of the hierarchical content directives for at least two modes and responding to actions registered within an application of the hierarchical content. For example, multiple keyboard codes may be transmitted substantially simultaneously for a single directive.

This may be used when multiple applications and/or the operating system can be controlled. A subset of applications may be specifically designed for this audio based interface and can customized for smart audio navigation, while other applications and possibly the operating system may be controlled through accessibility capabilities. In the Bluetooth keyboard version of the controller, the controller could transmit multiple keycodes: a first set of keycodes directed at the accessibility features of an operating system and a second set of keycodes to for applications responsive to smart audio directives.

Additionally, controlling navigation of the hierarchical content can include a controller transmitting or broadcasting to multiple devices or applications or alternatively switching between multiple devices or applications. For example, a controller apparatus may be able to cycle between browsing social media content via an application on a phone, adjusting the temperature settings on a smart thermostat, and changing the audio played over a connected sound system. Such switching can be achieved through a controller registering and connecting to multiple devices or applications. Alternatively, switching can be achieved through one or more applications on a single device managing communication to multiple devices or applications.

Controlling navigation of the hierarchical content can additionally include intelligently parsing content into a sequential list of content items, which functions to convert individual content items or sets of content items into format that can be presented through block Silo. In one variation, this can include summarizing content. For example, a folder or group of content may be summarized into one option presented to a user. Similarly, an email may be reduced to shorter summary. In another variation parsing content can include subdividing a single content item into a browsable set of options. For example, a webpage may be broken down into multiple sections that can be browsed in shorter summarized versions. In another variation, parsing content can include for at least a subset of the hierarchical content converting media content of a first format into hierarchically navigated content. For example, images or video may be processed via computer vision techniques and speech recognition on audio tracks can be used to create a summary of the content or create better audio representations of the content. In one variation, the method may include generating summaries of linked content from within a document and making the content accessible through an action. Links from webpages, document attachments, or other portions of content (e.g., addresses, phone numbers) may be made actionable so that a user can activate such links and navigate to that link either within the app or through deep linking to other applications.

Such parsing can be executed based on a set of heuristics and pattern detection approaches. Alternatively, machine learning or other forms of artificial intelligence can be used to customize the processing of content for a particular user, a particular class of user, or for the general user.

Block S130, which includes detecting a scrolling action and adjusting current state of the hierarchical content, functions to change the current selection state of an application. The scrolling action preferably cycles forwards and/or backwards through a set of options as shown in FIG. 11. The audio interface is preferably synchronized with the selection state such that a user executing a scrolling action triggers the audio interface to update and play audio corresponding to the current selection. To facilitate speed of navigation, audio cues and other audio properties may be used to provide mental shortcuts to browsing options. For example, in an email channel, scrolling actions can be used to jump to the next or previous email summary, but a short audio jingle mapped to a set of contacts may be played initially allowing a listener to quickly find an email sent from a particular contact. Detecting a scrolling action can include receiving a scrolling event from a rotary scrolling element of a controller device. That controller device is preferably an orientation-independent controller.

Block S140, which includes detecting a primary action and initiating a primary action of a currently selected item in the hierarchical content functions to trigger some action on the currently selected or active element in the hierarchical content. If the selected item is a navigational option (e.g., a folder or channel name), then that navigational option is opened and the corresponding options within that branch can be announced. If the selected item is a media content item (e.g., an audio file, an email, a social media message, or an article), then the media content item can be played or presented. If the selected item is an input element (e.g., a confirmation button, a toggle switch, or other audio interface element), then the state of the input element can be updated. Detecting a primary action can include receiving a button event from a first button of the controller device.

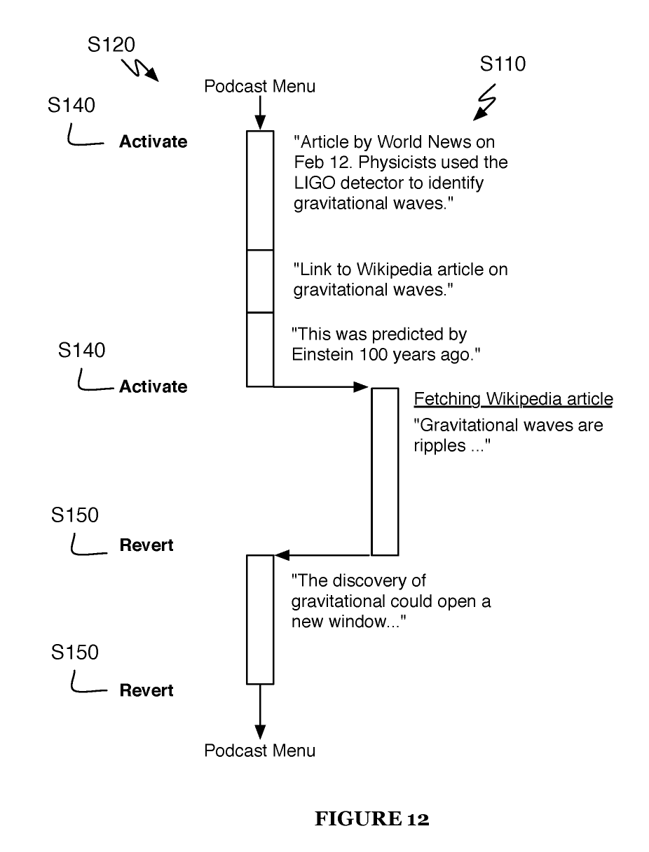

Block S150, which includes detecting a reverting action and returning to a previous state of the hierarchical content, which functions to offer a counter action to the primary action. The reverting action can trigger the state of the hierarchical content to be returned to a previous state as shown in FIG. 12. If the current state of the hierarchical content is navigating a particular channel of content (e.g., an email channel), then the reverting action can update the state to be navigating a parent channel (e.g., a main menu where the email channel is one of many possible channels). If the current state of the hierarchical content is playing a particular media item, then the reverting action can stop play and change the current state to be navigating the channel of that media item.

Detecting a reverting action includes receiving a button event from a second button of the controller device. The first button and the second button of the controller device are preferably arranged in an orientation-independent arrangement. Preferably, at least one of the first or second buttons circumscribes the corresponding the button in an orientation independent arrangement on the controller device. For example, the second button can be a ring shaped button that circumscribes the first button. Alternatively, the first button can a ring shaped button that circumscribes the second button.

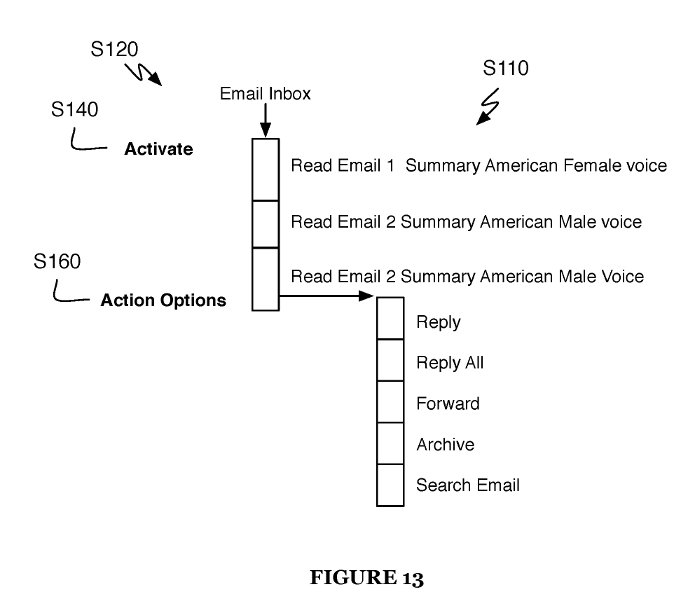

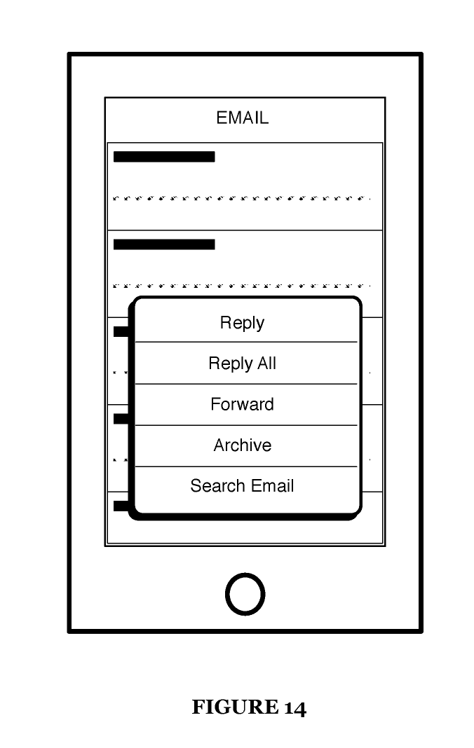

Controlling navigation of the hierarchical content may additionally include detecting an options action and contextually triggering action options for the current state of the hierarchical content S160, which functions to present a set of options based on the current situation. The action options are preferably a set of secondary actions that may be initiated during a particular state. The set of available actions may be based on the current channel, the currently selected item, and/or the state of media playback. In one exemplary scenario, if the current channel is an email channel, then the options may include a reply option, a reply all option, an archive/delete option, a quick response action, a remind me later option, a search option, and/or any suitable type of action as shown in FIGS. 13 and 14. In another exemplary scenario, if an article is being read the action options may include skip ahead, favorite the article, share the article, visit the previously listed link, or any suitable action.

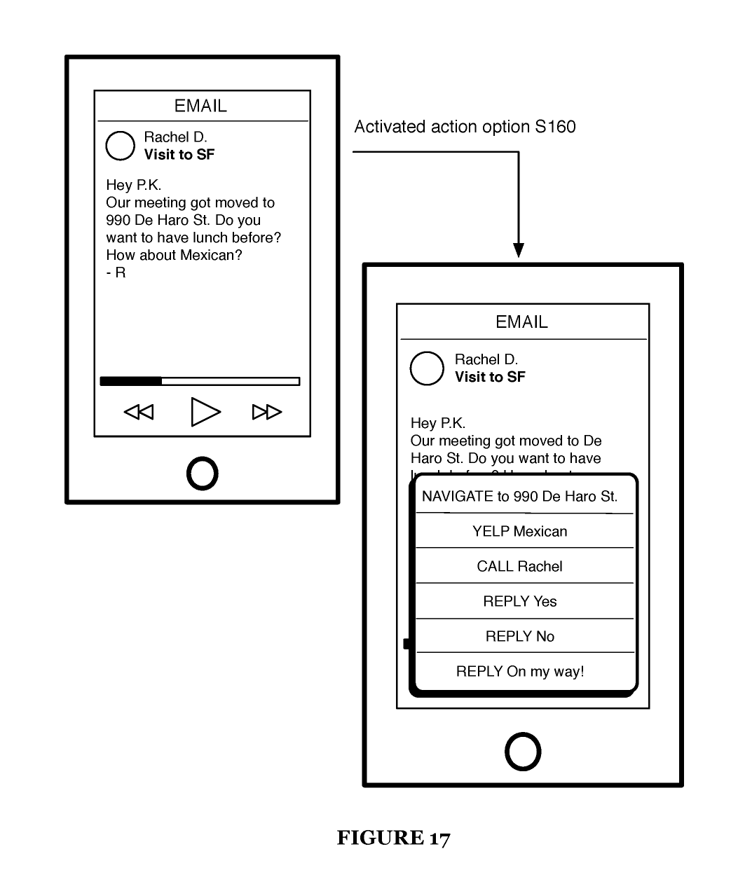

In one variation, the set of action options can be generated by intelligently parsing the content. Information can be extracted from the content and converted into a set of context-sensitive action options. The set of context-sensitive action options are preferably customized for a particular piece of content and can reduce and simplify interactions by reducing multi-step interactions to single actions. Machine learning, natural language processing, heuristics, and/or any suitable approach can be used in generating the responses. Preferably machine learning is used to analyze the content to extract context and content sensitive predicted actions. A set of different recognizers can be trained and applied to the content to target particular scenarios. There may be a machine intelligence recognizer for navigation, communication (e.g., making a call, sending a message, or other form of communication,), search queries (e.g., searching for a restaurant review, performing a web search, etc.), content responses (e.g., types of responses, content of responses, who is included in response, etc.), and/or any suitable type of recognizer. In one variation, the action options execute actions using deep-linking. Deep-linking can be used to hand a request over to a secondary application. Access of the secondary application can be accomplished through any suitable deep-linking mechanism such as intents (e.g., Android), openURL application methods (e.g., iOS), or other suitable techniques. Alternatively, an API or other mechanism may be used to execute an action within the application or on behalf of an application/service. In one example shown in FIG. 17, an email from a friend inquiring to the user's availability for grabbing some Mexican food may generate a set of action options that include a restaurant site search query for nearby Mexican food near, navigation directions to a nearby Mexican restaurant, an automated email response confirming the invite, an automated email declining the invite, and an action to create a calendar event.

Detecting an options action can include receiving a button event from a third button of the controller device. The third button can additionally be in an orientation independent arrangement with the first and second button. The first button, the second button, and the third button may be arranged in any suitable concentric arrangement.

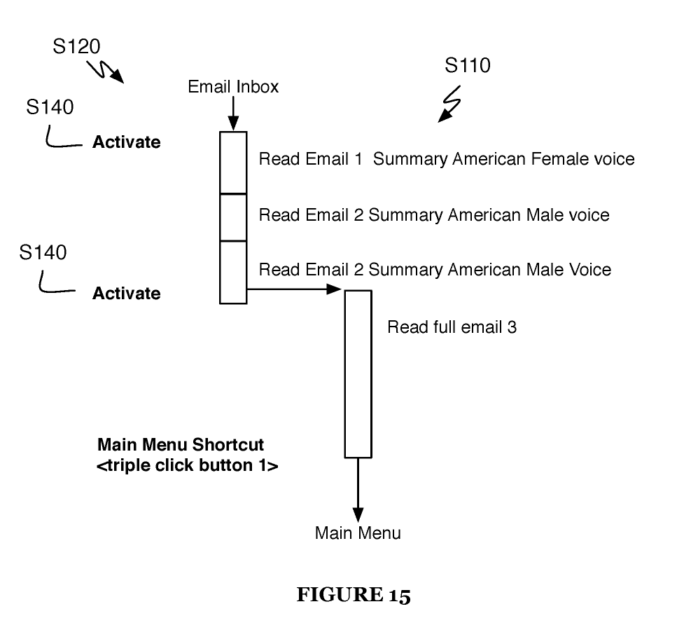

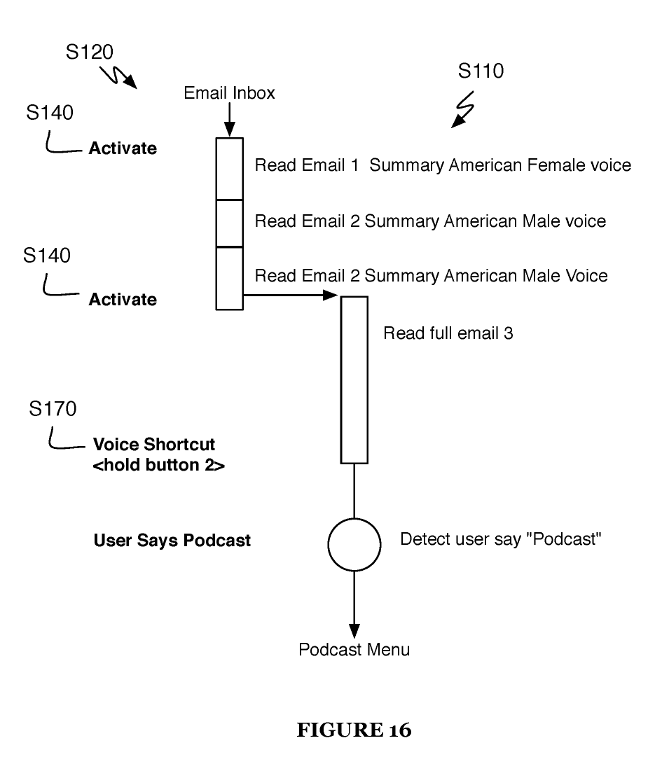

The various buttons can additionally include physical properties such as profile forms, textures, or materials that provide distinguishing features. Any one or more of the actions used in controlling navigation may be triggered through some pattern of input applied to the first button, second button, third button, rotary scrolling element, or any suitable input element. The pattern of input can be a pattern of multiple activations within a small time window (e.g., a double or triple click), a sustained press, activation with a particular pattern of pressure (e.g., hard vs. soft press), and/or any suitable pattern of activation to distinguish it from the default button press. For example, a triple click of a button may be a shortcut to return to the main menu as shown in FIG. 15, and a button hold can be used to initiate a voice command as shown in FIG. 16. The pattern of input may additionally be used for particular shortcuts or other actions such as returning to the main menu, jumping to a particular channel, pausing audio playback, changing volume, changing playback speed, skipping ahead or backwards, or performing any suitable action

In another variation, the method may integrate the use of natural language user input interface, wherein spoken commands or spoken requests can be used. Accordingly, controlling navigation of the hierarchical content can include receiving a spoken directive and updating the state of the hierarchical content according to the spoken directive S170. The use of spoken directives can be used for completing tasks to which the tactile-based controller is not the preferred mode. For example, entering text may be more easily completed by speaking. Similarly, some shortcuts in interacting with the hierarchical content can additionally or alternatively be completed through spoken directives. For example, saying “podcast” may jump the state of the hierarchical content to the podcast channel as shown in FIG. 16.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A system for a user interface comprising:
a controller apparatus with a set of inputs that comprises at least two buttons and a rotary scrolling input element;
a data connection between the controller apparatus and at least one navigable hierarchy of content;
the rotary scrolling input element configured to communicate a change in selection state in the at least one navigable hierarchy of content;
a first button configured to communicate a primary action on a currently selected item in the at least one navigable hierarchy of content; and
a second button configured to communicate a secondary action to the current state of the navigable hierarchy of content.

2. The system of claim 1, further comprising:
an audio engine that presents an audio interface output in response to communicated actions and navigation state of the hierarch of content;
wherein at least one of the two buttons is circumscribed by the other button.

3. The system of claim 2, further comprising a third button integrated with the rotary scrolling input element, wherein the third button is configured to communicate an options action according to the current state of the navigable hierarchy of content.

4. The system of claim 2, wherein the audio engine is operable on a secondary device and further comprises an audio content browser and a set of voice synthesizers, wherein the audio content browser is configured to translate media content to an audio description using one of the set of voice synthesizers.

5. The system of claim 1, wherein the controller apparatus comprises a fixture interface compatible with a steering wheel.

6. The system of claim 1, wherein the first button is additionally configured to communicate an option action upon detecting a pattern of button events.

7. The system of claim 1, wherein the controller apparatus is configured for at least two modes of control over at least two types of navigable hierarchies of content; wherein the action commands for the at least two modes of control are transmitted simultaneously through the data connection.

8. The system of claim 7, wherein the first mode of control is smart audio navigation for an application with audio navigation integration and the second mode of control is an accessibility mode for device accessibility tools.

9. The system of claim 1, wherein the data connection between the controller apparatus and the at least one navigable hierarchy of content is switched to at least a second navigable hierarchy of content, wherein a first navigable hierarchy is for a first device, and the second navigable hierarchy of content is for a second device.

10. A method for audio browsing comprising:
presenting a hierarchical content through at least an audio interface;
controlling navigation of the hierarchical content in response to a set of actions comprising:
detecting a scrolling action and adjusting current state of the hierarchical content to
detecting a primary action and initiating a primary action of a currently selected item in the hierarchical content; and

11. The method of claim 10, further comprising detecting a reverting action and returning to a previous state of the hierarchical content; wherein detecting a scrolling action comprises receiving a scrolling event from a rotary scrolling element of a controller device; wherein detecting a primary action comprises receiving a button event from a first button of the controller device; wherein detecting a reverting action comprises receiving a button event from a second button of the controller device; wherein at least one of the first or second button circumscribes the corresponding button in an orientation independent arrangement on the controller device.

12. The method of claim 11, wherein controlling navigation of the hierarchical content further comprises detecting an options action and contextually triggering action options for the current state of the hierarchical content.

13. The method of claim 12, wherein the triggering action options comprises generating a set of context-sensitive action options through machine learning analysis of content from the currently selected item in the hierarchical content and presenting the set of context-sensitive action options.

14. The method of claim 12, wherein detecting an options action comprises receiving a button event from a third button of the controller device; wherein the third button is an orientation independent arrangement with the first and second button.

15. The method of claim 12, wherein detecting an options action comprises detecting a pattern of input from one of the first button or the second button.

16. The method of claim 11, wherein presenting the hierarchical content comprises rendering the hierarchical content visually in a modular navigation mode.

17. The method of claim 11, further comprising for at least a subset of the hierarchical content converting media content of a first format into hierarchically navigated content.

18. The method of claim 17, wherein converting media content comprises applying artificial intelligence in customizing the converting of media content.

19. The method of claim 17, wherein converting media content comprises generating summaries of linked content from within a document and making the content accessible through an action.

20. The method of claim 10, wherein controlling navigation of the hierarchical content comprises receiving a spoken directive and updating the state of the hierarchical content according to the spoken directive.
